(19) United States
(12) Patent Application Publication
(10) Pub. No.: US 2003/0093680 A1
(43) Pub. Date: May 15, 2003

(54) Methods, apparatus and computer programs performing a mutual challenge-response authentication protocol using operating system capabilities

(75) Inventors: Mark C. Astley, Pompton Lakes, NJ (US); Neil George Stanley Young, Southampton (GB)

Correspondence Address: IBM Corp, IP Law Dept T81/503, 3030 Cornwallis Road, PO Box 12195, Research Triangle Park, NC, 27709-2195, US

(73) Assignee: International Business Machines Corporation, Armonk, NY (US)

(21) Appl. No.: 10/007,859

(22) Filed: Nov. 13, 2001

(51) Int. Cl. H04K 1/00

(52) U.S. Cl. 713/183

(57) ABSTRACT

A client-server authentication method for use where a server process has access to a repository storing cipher-protected client passwords. The method includes applying the same cipher function to the client's copy of its password as was previously applied to generate the stored cipher-protected client passwords. This ensures that both the client and server have access to an equivalent cipher-protected client password—providing a shared secret for driving a mutual challenge-response authentication protocol without having to convert the password into cleartext at the server. The invention can be implemented without significant additional software infrastructure in a UNIX environment. Client passwords are typically stored in the UNIX password repository under the protection of the crypt( ) function applied to the combination of the password and a random number (a ‘salt’). By sending the salt to the client system together with the server's initial challenge of the authentication protocol, a process at the client is able to apply the crypt( ) function to the client password with the same salt such that the client and server have a shared secret for use as, or to generate, a common session key for the authentication.

### FIELD OF INVENTION

The present invention relates to authentication of communication partners in a data processing network.

### BACKGROUND

Mutual challenge-response authentication protocols are well known and widely implemented in the software industry. The protocols require the generation of a secret session key in each of a client and server. The client and server prove to each other that they know this secret through a server challenge and client response-and-counter-challenge which protects against discovery of passwords by snooping of client-server connections (for example, by a “man-in-the-middle”).

One variant of the mutual challenge-response authentication protocol involves the computation of the secret session key using the client's password. This requires that the server has access to a database of client user ID's and passwords. In many implementations of this protocol the password is held in clear text at each end of the communication link. A typical authentication protocol using cleartext passwords can be described as follows. The client connects to the server. The server identifies itself as S and sends a random number Rₛ “challenge” to the client. The client responds with its own identity, C, a random challenge of its own choosing R_{c} and the MAC (message authentication code) of the message string {S+Rₛ+C+R_{c}+“Client”}. The MAC is computed using its password, P_{c}, as the MAC key. (The “+” symbol is used here to represent concatenation of bit strings.) If the server is satisfied that the client knows its password, then the server proves that it also knows the password by responding with the MAC of the message string {S+Rₛ+C+R_{c}+“Server”} computed using the (same) password, P_{c}, as the MAC key. This is represented in FIG. 1.

Such protocols are designed to avoid “reflection” attacks and “replay” attacks. Because the client must satisfy the server's challenge before the server satisfies the client's challenge, an attacker impersonating a client can gather no information to mount an “offline” password guessing attack. Because both the client and the server prove to each other that they know the password, this protocol is invulnerable to “impersonation” attacks. Even if someone intercepts a MAC coded string, it is computationally very difficult to infer the password from the string and hence it is very difficult to “spoof” a client or server.

U.S. Pat. No. 5,872,917 discloses a method of mutual authentication of communication partners using a password as a shared secret. The authenticating parties prove that they know the shared password without revealing the password during the data exchange of the authentication protocol.

However, holding passwords in cleartext at both ends of the communication link for use in the authentication protocol still represents a security exposure for these known solutions. Even though hard to compute from the data string which is sent across the network, the fact that the password is held (even if only briefly) in cleartext form on the server entails a security exposure. Furthermore, some operating systems do not permit retrieval of passwords in cleartext form from their password databases.

Alternative solutions which provide a greater level of security, such as the Kerberos authentication service or Secure Sockets Layer (SSL) which uses public and private key authentication, require significant additional software infrastructure for their implementation—such as creation and maintenance of an additional secure password repository. Additionally, relatively secure solutions such as SSL require more computational resources (i.e. tend to be slower) than relatively weak solutions such as simple Telnet-like password authentication.

The result of these problems has been that known implementations of the mutual challenge-response authentication protocol on UNIX systems have required significant additional software infrastructure and processing time.

There is a need to provide improved security for a mutual challenge-response password authentication protocol without the need for significant additional software infrastructure.

### SUMMARY OF INVENTION

According to a first aspect, the present invention provides an authentication method for a distributed data processing environment in which a server data processing system has access to a repository storing cipher-protected client passwords, the cipher-protected client passwords having been generated by applying a cipher function to the client passwords, the method comprising: a process at the client data processing system applying the same cipher function to the client password which corresponds to the stored cipher-protected client password, thereby to generate a cipher-protected client password which is equivalent to the stored cipher-protected client password; performing an authentication check using the client data processing system's cipher-protected client password and the server data processing system's stored cipher-protected client password as a shared secret for said authentication check.

The cipher-protection may be any form of cryptographic protection including encryption (in which the cipher function is a reversible encryption algorithm, requiring a decryption key for reversal) or hashing (in which the cipher function is a non-reversible hash function). The client and server processes are configured to use a consistent cipher function, or they negotiate which cipher function to use. The client and server processes agree a password for this client as a first stage of the method, and the server stores this for subsequent use.

The authentication checking preferably comprises generating a common secret session key from the cipher-protected client password (for example, by hashing an encrypted password) and using this common secret session key in a mutual challenge-response authentication protocol. The server data processing system's password repository is preferably the server system's operating system's own password repository.

According to a preferred embodiment, the invention provides an authentication method for a distributed data processing environment in which a server data processing system has access to a repository storing encrypted client passwords, each encrypted client password being stored together with a token such as a respective random number (a ‘salt’), the encrypted client passwords having been generated by combining the client passwords with the respective token and applying an encryption algorithm to the combination. The method comprises: a process at the server data processing system retrieving from the repository the respective token for a stored encrypted client password, and transmitting the token to a client data processing system; a process at the client data processing system applying the encryption algorithm to the combination of the transmitted token and the client password which corresponds to the stored encrypted client password, thereby to generate an encrypted client password which is equivalent to the stored encrypted client password; and using the client data processing system's encrypted client password and the server data processing system's stored encrypted client password as a shared secret for authentication checking.

The present invention is particularly applicable to server data processing systems running the UNIX operating system environment. UNIX is both an operating system and an open standard for operating systems. Originally developed in 1969 at Bell Laboratories, UNIX has evolved into an open standard with many extensions and specific implementations provided by different companies, universities, and individuals. The UNIX environment and the client/server program model were important elements in the development of the Internet and network-centric computing. UNIX-based operating systems are used in widely-sold workstation products (for example, from IBM Corporation, Sun Microsystems and a number of other companies). The Linux operating system is a derivative of UNIX which is increasing in popularity as an alternative to proprietary operating systems. Herein, for simplicity, all operating systems which are based on or derived from the UNIX operating system, or conform to the UNIX operating system standards, will be referred to by example as ‘the UNIX operating system’. (UNIX is a registered trademark of The Open Group).

A significant insight of the present invention is the inventors' recognition that knowledge of the cipher function applied to a password before storing it in the UNIX operating system's password repository at the server enables the client to compute an equivalent cipher-protected password to that which is already held on the server. For example, many operating systems which conform to the UNIX standard use the widely available crypt( ) function applied to the combination of the password and a random number or ‘salt’, whereas the Linux operating system uses a hash function. The stored and computed copies of a cipher-protected password provide a common secret session key, either directly or by providing a shared secret from which a session key is generated, with which to drive the mutual challenge-response authentication protocol.

This ability to exploit cipher-protected passwords drawn from the existing password repository avoids the security exposure associated with the perceived requirement to decrypt client passwords to cleartext on the server, while also avoiding the additional software infrastructure requirements of other known solutions.

The invention may be implemented as a computer program product or a set of computer program components, comprising program code recorded on one or more machine-readable recording media (such as a magnetic or optical medium), for performing the method described above.

In further aspects, the invention provides each of a client process and server process for mutual challenge-response authentication in a distributed client-server data processing system, and provides each of a client and server data processing system including the respective client and server processes.

The server process has access to a repository storing a cipher-protected copy of client passwords, the cipher protected client passwords having been generated by applying a first cipher function to the client passwords. The server process can respond to a client process indicating a requirement for an operation to be performed, by generating a server challenge and for transmitting the server challenge to the client process. The client process can then generate a cipher-protected client password by applying the same cipher function to the client's password. This provides the client and server processes with a shared secret. Then, the client process can generate a client response and counter-challenge including a message authentication code computed using the cipher-protected client password, and forward it to the server process. The server process receives the client response and counter-challenge from the client process. The server process accesses the repository to retrieve the stored cipher-protected client password, and generates (using said stored cipher-protected client password) a message authentication code corresponding to an anticipated client response and counter-challenge. The server process then compares the received and generated message authentication codes to determine whether they match. Responsive to a match, the server process generates a server response to the client response and counter-challenge, and forwards this to the client process to enable the client process to perform an authentication check.

### BRIEF DESCRIPTION OF DRAWINGS

A preferred embodiment of the present invention will now be described in more detail, by way of example, with reference to the accompanying drawings in which:

FIG. 1 is a representation of a typical mutual challenge-response authentication protocol;

FIG. 2 is a schematic representation of a client-server data processing environment in which the present invention may be implemented; and

FIG. 3 is a representation of an authentication protocol according to an embodiment of the present invention.

### DESCRIPTION OF PREFERRED EMBODIMENT

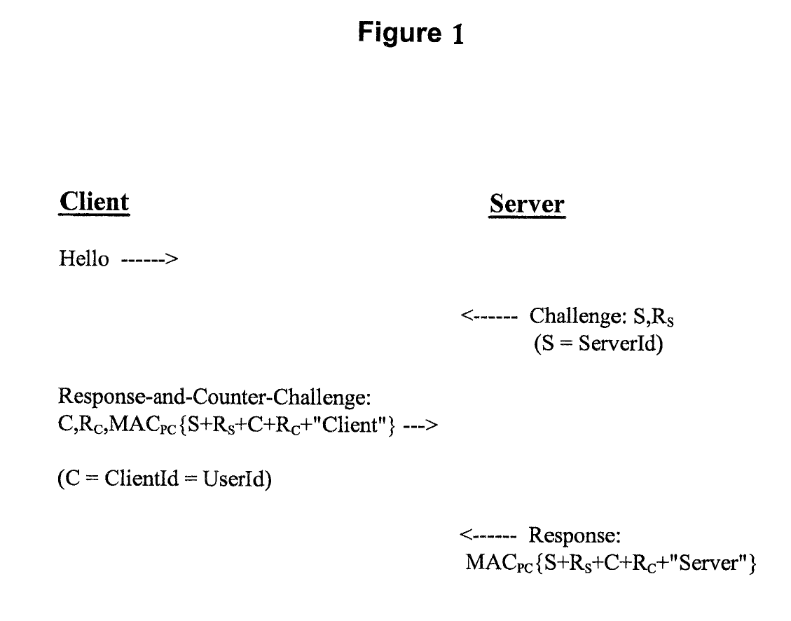

As described previously, FIG. 1 represents a typical mutual challenge-response password authentication protocol. According to the preferred embodiment of the present invention, such a protocol can be deployed without exposing passwords in cleartext at the server and without the requirement for additional software infrastructure. In particular, there is no requirement for the creation and maintenance of an additional password database—the UNIX operating system capabilities are exploited instead.

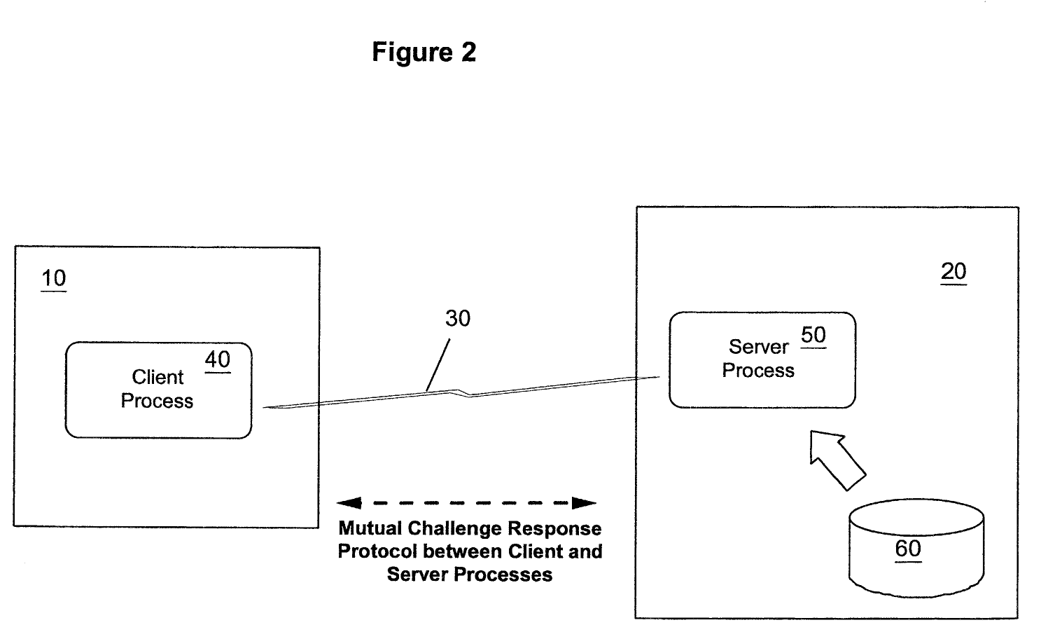

FIG. 2 shows a client data processing system 10 with a communication link 30 to a server data processing system 20. As is well known in the art, the client-server paradigm does not imply any limitation on the nature of the data processing systems involved, but indicates instead the current relationship between processes running on the two systems—i.e. for a current task, the client process 40 is requesting services from the server process 50. The server data processing system may be any data processing system, but is preferably running the UNIX operating system (as described above, this may include any operating system based on, derived from or conforming to the UNIX operating system or standard). The client data processing system may also be any system, but in particular it may be a desktop workstation or a portable computer (or a PDA having limited memory and/or processing resources) which connects to the server via the Internet, an intranet, or any other local or wide area, mobile or fixed-wire network.

The mutual challenge-response authentication protocol requires the generation of a secret session key in each of a client and server. The client and server prove to each other that they know this secret through a server challenge and client response-and-counter-challenge.

The server computes its secret session key from encrypted passwords stored in the Unix operating system's own password repository. The equivalent encrypted password is computed in the client using the UNIX crypt( ) system call, or an equivalent, applied to the client's clear text password. A common secret session key may then be generated from these encrypted passwords with which to drive the mutual challenge-response protocol.

The wide availability of implementations of the crypt( ) function on multiple platforms allows this implementation of the protocol to be supported by a wide range of client platforms. The client is also able to generate a hash of the encrypted password. So the total requirements on the client in this preferred embodiment are a way to encrypt a cleartext password consistently with the encryption which was applied to client passwords at the server, and a way to hash elements of the challenge. The crypt( ) function may be used for both.

There is never a requirement for cleartext passwords to be stored at the server. Thus, at least the level of privacy guaranteed by existing UNIX security is maintained, without requiring complicated additional client infrastructure. The solution is therefore easy to implement with existing technology.

The UNIX operating system stores passwords in an encrypted form but does provide interfaces for their retrieval. The getpwent( ) system call, for example, will retrieve the encrypted password for a specified username. The DES-encryption based mechanism used by the UNIX operating system to generate the encrypted password from a clear text password is exposed in the Unix crypt( ) system call. The crypt( ) function requires two parameters, the clear text password and a two character (12 bit) random number known as a “salt” used by the encryption algorithm. The resultant encrypted password as stored in the user/password repository at the server is always prepended by the two character salt.

The purpose of the salt is to significantly slow down off-line password guessing where somebody has gained access to the whole file of encrypted passwords and is mounting a “dictionary attack”. i.e. they hash all the words in a dictionary and check to see whether any of the passwords match any of the stored hashed values. The presence of the salt does not make it any harder to guess one user's password, but it makes it impossible to perform a single hash operation and see whether a password is valid for any of a group of users.

crypt( ) takes a password and salt as input. The encrypted password is converted into a secret key. The salt is used to define a modified DES algorithm which is used with the secret key to encrypt a constant value in order to yield a hash.

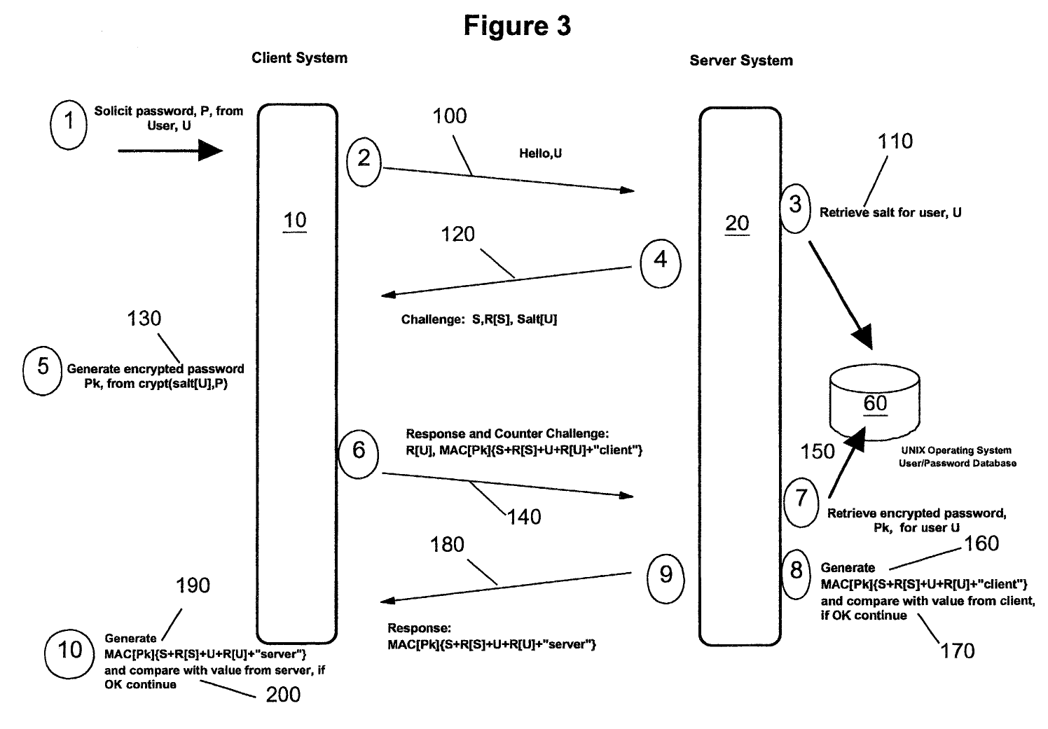

The sequence of events and information flows according to the preferred embodiment of the invention will now be described with reference to FIG. 3. The following is a Key to the information items flowing between the systems in FIG. 3:

U—User Identifier;

P—cleartext password for user U;

R[U]—random challenge from client;

Salt[U]—salt for user U;

S—Server Identifier;

R[S]—random challenge from server;

Pk—encrypted password for user U;

MAC[Pk]{str}—Message Authentication Code(MAC) of a string, str, computed using Pk as the MAC key.

Let us assume that a process running on the client system requires communications to be established with the server, such as when a subscriber application program running on a client data processing system wishes to register with a publish/subscribe message broker running on the server, to receive publications from the broker. The client and the server may both require some authentication of the other system or process before they can commence communications of secure data. This may because specific data to be published is confidential, to protect the server system from unauthorised accesses, or it may be to ensure that only paid-up users get access to costly resources, etc.

Firstly, a process running on the client data processing system makes contact 100 with the server, flowing the client identity to the server. The server then extracts 110 the appropriate encrypted password from the Unix operating System and flows 120 the prepended salt to the client as part of its challenge. The client is then able to generate 130 the secret session key, in order to drive the remainder of the challenge response protocol, by calling crypt( ) against its clear text password and the received salt.

The client sends 140 its response and counter-challenge to the server. This comprises a random challenge from the client and a message authentication code (MAC) of the string {S+R[S]+U+R[U]+“client”}, computed using the encrypted password as the MAC key. The server retrieves 150 the encrypted password for the current user from the UNIX operating system's user/password database, and uses this to generate 160 the message authentication code MAC[Pk]{S+R[S]+U+R[U]+“client”}. This is then compared 170 with the value received from the client. If there is a match, the server views the authentication as successful and so the communication flows of the authentication protocol can continue.

A response is sent 180 back to the client, including the message authentication code MAC[Pk]{S+R[S]+U+R[U]+“server”}. The equivalent message authentication code MAC[Pk]{S+R[S]+U+R[U]+“server”} is also computed 190 at the client and compared 200 with the incoming MAC. If they match, authentication has been successful at both ends and communication can continue.

This authentication protocol may be implemented as one of a selection of protocols available for use by a publish/subscribe message broker product. The broker may be configurable to use different authentication protocols for different purposes or different users, since different customer scenarios may have different security and other performance or solution architecture requirements.

For example, a publish/subscribe message broker implementing the invention may support the following set of protocols.

i. Simple telnet-like password authentication

ii. Mutual challenge-response password authentication

iii. SSL (Secure Socket Layer) “hybrid” with public key authentication of server and password authentication of the client

iv. SSL “pure” with public key authentication of server and client

These protocols vary in strength against “attacks” (i.e. from relatively weak in the case of i to relatively strong in the case of iv), required “infrastructure” (little in the case of i and ii, to considerable in the lo case of iv) and in terms of computational resources required (i.e. authentication performance is “fast” in i but “slower” in iv).

In this case, the broker network's use of authentication protocols is configurable.

A broker may be configured to support either (a) no or (b) one or (c) a set of protocols.

A client may similarly be configured to support either (a) no or (b) one or (c) a set of protocols.

Different clients may be configured to connect to the same broker with different protocols (clients and servers “negotiating” the authentication protocol to use)

A “minimum strength” protocol may be specified for a particular user or set of users, or for a particular publish/subscribe topic.

A customer might require one level of security for a test or evaluation environment but a different level of security for a production environment. Other customers might require that local users connect to a broker via one protocol while users who wish to access the broker over the Internet use a stronger protocol. Customer's requirements can also change over time, and a solution implementing a range of configurable authentication options allows them to adapt their broker environments appropriately. Customers with high performance requirements might choose a less strong protocol and secure their environment by other means.

The mutual challenge-response protocol described in detail above can thus be provided within computer program products as a “mid-range” option (in terms of security strength, computational requirements and administrative overhead) in a range of authentication protocols. Its presence strengthens the overall solution and the ease of re-configuring protocols increases the likelihood of its use.

1. An authentication method for a distributed data processing environment in which a server data processing system has access to a repository storing cipher-protected client passwords, the cipher-protected client passwords having been generated by applying a cipher function to the client passwords, the method comprising:
a process at the client data processing system applying the cipher function to the client password which corresponds to the stored cipher-protected client password, thereby to generate a cipher-protected client password which is equivalent to the stored cipher-protected client password;
performing an authentication check using the client data processing system's cipher-protected client password and the server data processing system's stored cipher-protected client password as a shared secret for said authentication check.

2. A method according to claim 1, wherein the authentication check includes performing a mutual challenge-response authentication protocol check.

3. A method according to claim 1, wherein the cipher function is an encryption algorithm.

4. A method according to claim 3, wherein the authentication check comprises generating a common secret session key at both the client and server data processing systems, using the generated encrypted client password at the client and the stored encrypted client password at the server, and using this common secret session key in a mutual challenge-response authentication protocol.

5. A method according to claim 4, wherein the common secret session key is generated by applying a cipher function to each of the generated encrypted client password at the client and the stored encrypted client password at the server.

6. A method according to claim 1, wherein the cipher function is a hash function.

7. A method according to claim 1, wherein each cipher-protected client password stored in the repository is stored together with a respective token, and the cipher-protected client passwords are generated by combining the client passwords with the respective token and applying the cipher function to the combination, and wherein the method includes:
a process at the server data processing system retrieving from the repository the respective token for a stored cipher-protected client password, and transmitting the token to a client data processing system; and
the process at the client data processing system applying the cipher function to the combination of the transmitted token and the client password which corresponds to the stored cipher-protected client password, thereby to generate the equivalent cipher-protected client password for use as a shared secret.

8. A method according to claim 7, wherein the token is a random number.

9. A method according to claim 1, wherein the server data processing system's password repository is preferably integrated within the operating system of the server data processing system.

10. method according to claim 9, wherein the operating system is an operating system conforming to the UNIX operating system standard or derived from a UNIX conforming operating system.

11. A method according to claim 10, wherein the encryption algorithm is provided by the UNIX crypt( ) function.

12. An authentication method for a distributed data processing environment in which a server data processing system has access to a repository storing cipher-protected client passwords, each cipher-protected client password being stored together with a respective token, the cipher-protected client passwords having been generated by combining the client passwords with the respective token and applying a cipher function to the combination, the method comprising:
a process at the server data processing system retrieving from the repository the respective token for a stored cipher-protected client password, and transmitting the token to a client data processing system;
a process at the client data processing system applying the cipher function to the combination of the transmitted token and the client password which corresponds to the stored cipher-protected client password, thereby to generate a cipher-protected client password which is equivalent to the stored cipher-protected client password; and
using the client data processing system's cipher-protected client password and the server data processing system's stored cipher-protected client password as a shared secret for a mutual challenge-response authentication check.

13. A computer program product comprising program code recorded on a machine-readable recording medium, wherein the program code includes a server process for participating in a mutual challenge-response authentication protocol, the server process having access to a repository storing a cipher-protected copy of client passwords, the cipher protected client passwords having been generated by applying a first cipher function to the client passwords, the server process comprising:
means, responsive to a client process indicating a requirement for an operation to be performed, for generating a server challenge and for transmitting the server challenge to the client process, thereby to enable the client process:
(i) to generate a cipher-protected client password by applying said first cipher function to the client's password, thereby to provide the client and server processes with a shared secret; and then
(ii) to generate a client response and counter-challenge, the client response and counter-challenge including a message authentication code computed using the cipher-protected client password, and to forward it to the server process;
means for receiving the client response and counter-challenge from the client process;
means for accessing the repository and retrieving said stored cipher-protected client password;
means for generating, using said stored cipher-protected client password, a message authentication code corresponding to an anticipated client response and counter-challenge, and for comparing the received and generated message authentication codes to determine whether they match;
means, responsive to a match, for generating a server response to the client response and counter-challenge; and
means for forwarding the server response to the client process to enable the client process to perform an authentication check.

14. A computer program product, comprising program code recorded on a machine-readable recording medium, wherein the program code includes a client process for participating in a mutual challenge-response authentication protocol, the client process comprising:
means for indicating to a server process a requirement for an operation to be performed, thereby prompting the server process to generate and send a server challenge to the client process;
means for applying a cipher function to the client's password to generate a cipher-protected client password;
means, responsive to receipt of the server challenge, for generating a client response and counter-challenge, the client response and counter-challenge including a message authentication code computed using the cipher-protected client password;
means for forwarding the client response and counter-challenge to the server process, thereby to prompt the server process to:
(i) receive the client response and counter-challenge;
(ii) access a repository storing a cipher-protected client password, generated by applying said cipher function to the client's password, to retrieve said stored cipher-protected client password;
(iii) generate, using said stored cipher-protected client password, a message authentication code corresponding to an anticipated client response and counter-challenge;
(iv) compare the received and generated message authentication codes to determine whether they match and, responsive to a match, to generate a server response to the client response and counter-challenge and to forward the server response to the client process;
wherein the client process also includes:
means for generating a message authentication code corresponding to an anticipated server response,
means for receiving the forwarded server response, and
means for comparing the forwarded and anticipated server responses to determine whether they match.

15. A data processing system including:
a repository storing a cipher-protected copy of client passwords, the cipher-protected client passwords having been generated by applying a first cipher function; and
a server process for participating in a mutual challenge-response authentication protocol with a client process having an associated client password, the server process comprising:
means, responsive to a client process indicating a requirement for an operation to be performed, for generating a server challenge and for transmitting the server challenge to the client process, thereby to enable the client process:
(i) to generate a cipher-protected client password by applying said first cipher function to the client's password, thereby to provide the client and server processes with a shared secret; and then
(ii) to generate a client response and counter-challenge, the client response and counter-challenge including a message authentication code computed using the cipher-protected client password, and to forward it to the server process;
means for receiving the client response and counter-challenge from the client process;
means for accessing the repository and retrieving said stored cipher-protected client password;
means for generating, using said stored cipher-protected client password, a message authentication code corresponding to an anticipated client response and counter-challenge, and for comparing the received and generated message authentication codes to determine whether they match;
means, responsive to a match, for generating a server response to the client response and counter-challenge; and
means for forwarding the server response to the client process to enable the client process to perform an authentication check.

16. A distributed data processing system comprising a first data processing system according to claim 14 and a client data processing system, the client data processing system including a client process for:
generating a cipher-protected client password by applying said first cipher function to the client's password, thereby to provide the client and server processes with a shared secret;
generating a client response and counter-challenge to the server challenge, the client response and counter-challenge including a message authentication code computed using the cipher-protected client password;
forwarding the client response and counter-challenge to the server process;
receiving the forwarded server response;
generating an anticipated server response and comparing the received and anticipated server responses to determine whether they match; and
in response to a positive match, confirming successful authentication.
